(19) United States
(12) Patent Application Publication
(10) Pub. No.: US 2013/0108749 A1
(43) Pub. Date: May 2, 2013

(54) Muffinmeal™

(71) Applicants: William Roger Bombard, Wheaton, IL (US); Elke Mildred Quade, Willow Springs, IL (US)

(72) Inventors: William Roger Bombard, Wheaton, IL (US); Elke Mildred Quade, Willow Springs, IL (US)

(21) Appl. No.: 13/285,580

(22) Filed: Oct. 31, 2011

(51) Int. Cl. A23P 1/08; B41B 11/62

(52) U.S. Cl. 426/280; 249/155

(57) ABSTRACT

Muffinmeal™ is a baking accessory used to form cavities of various sizes and shapes in the top of cupcakes, muffins or other baked goods. The baking accessory consists of two components. A cavity forming attachment and the base/stem embodiment are assembled to form the desired cavity. The interface between the stem and the receiving hole in the base of the cavity forming attachment allow for repeatable vertical adjustment of the cavity forming attachment.

The Muffinmeal™ baking accessory creates an exposed cavity on top of the baked surface that can be filled with various food products. The Muffinmeal™ baking accessory allows the baked mixture to rise un-constricted, producing a naturally rounded and aesthetically pleasing baked surface.

### OVERVIEW

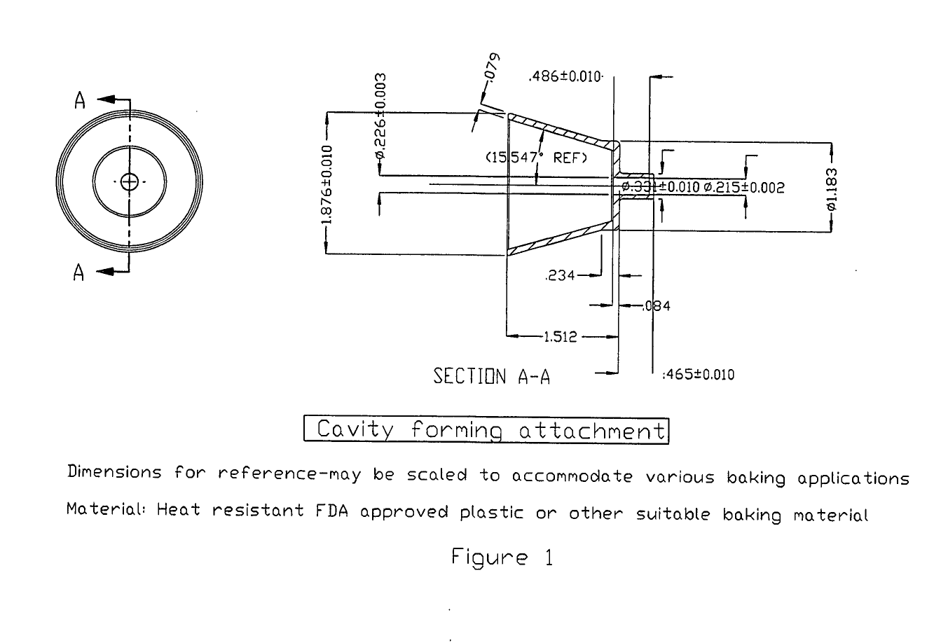

FIG. 1 contains the embodiment of a cavity forming component of the Muffinmeal™ baking accessory. This embodiment is for forming a cavity having a round cross section in the item being baked. The dimensions shown are for reference and may be adjusted to enable the assembled unit to fit in the respective baking container such as a cupcake, muffin or baking pan.

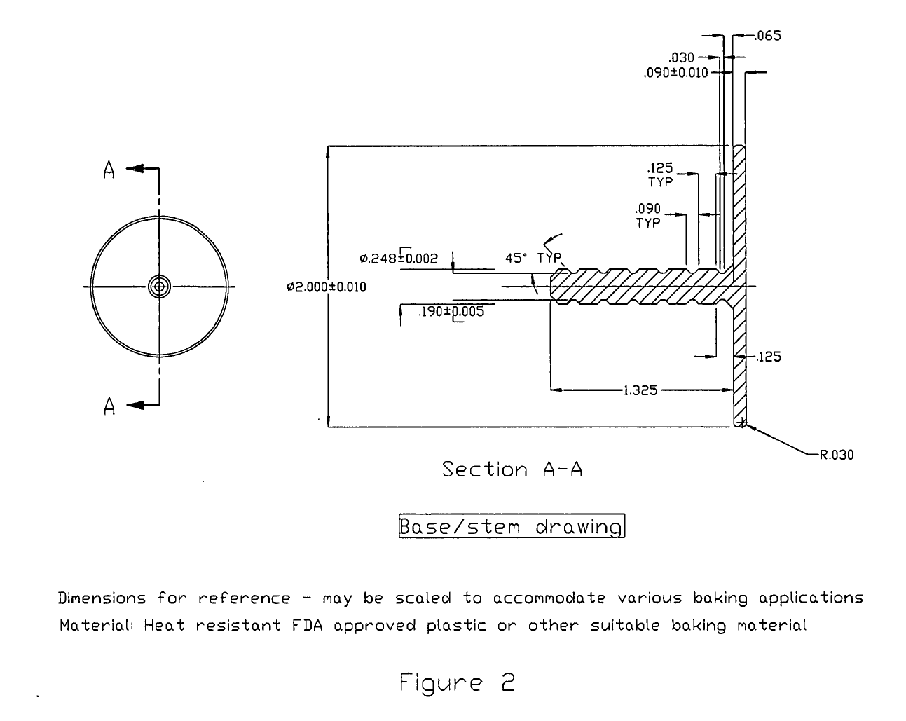

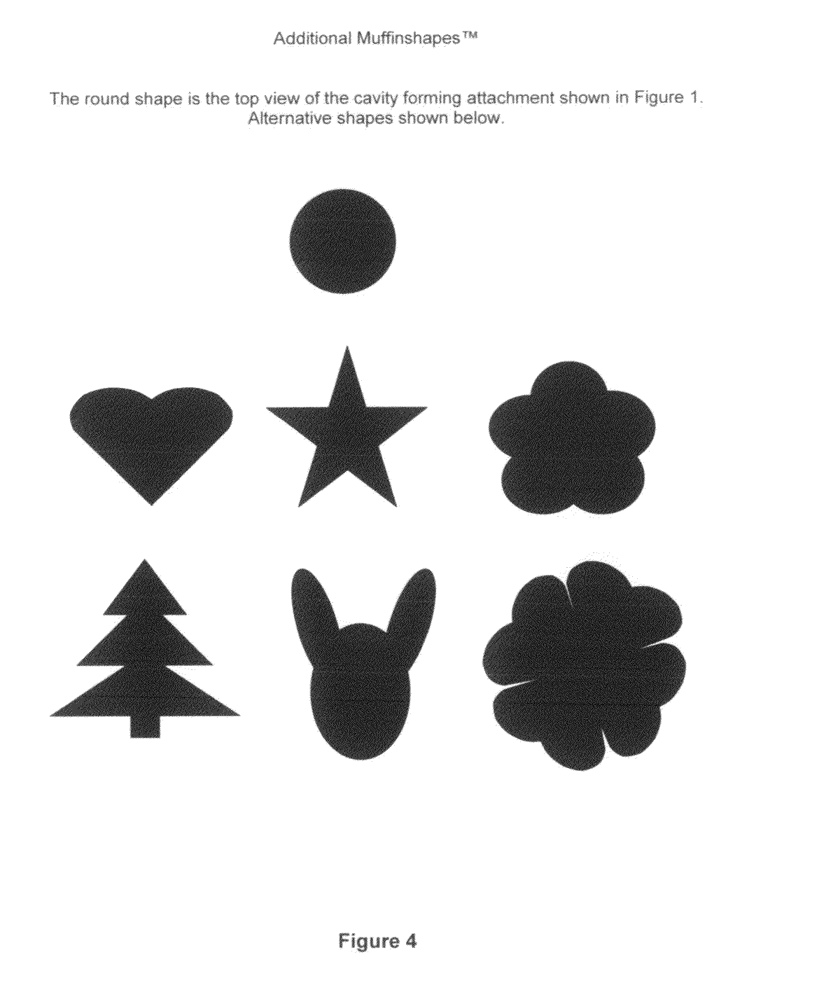

FIG. 2 contains an example of the base/stem embodiment that is used in conjunction with the forming embodiment shown in FIG. 1 or alternative cavity forming shaped embodiments, Muffinshapes™, shown in FIG. 4.

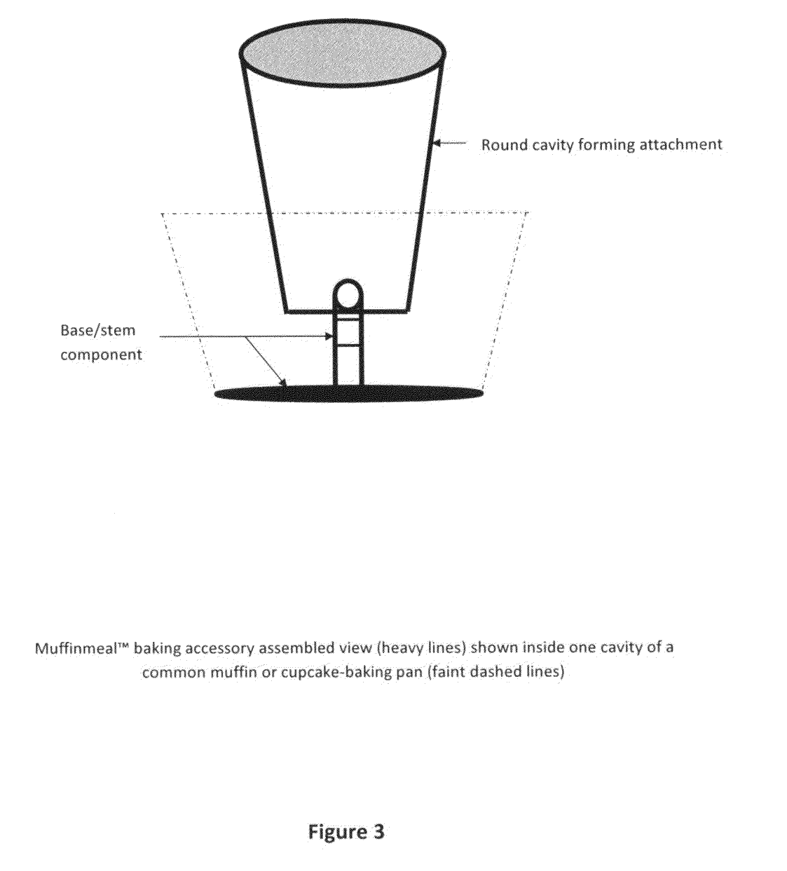

FIG. 3 contains a rendering of the elevation view of the Muffinmeal™ baking accessory in one segment of a cupcake or muffin pan cavity. This rendering also contains a brief explanation of operation and features.

FIG. 4 contains geometric representations of additional cavity forming attachments, Muffinshapes™, which can be used to create a cavity in the items being baked. These additional attachments form fun shapes that create opportunities for all ages to exercise their creative decorating skills while making delicious meals or desserts.

### DETAILED DESCRIPTION OF INVENTION

The manufacture of the invention can be conducted in several ways depending on the material chosen. Injection molding processes will be utilized to manufacture the invention from plastic materials. If the invention is to be made from a metal composition the processes will be machining and or stamping. The embodiments shown in FIGS. 1 & 2 must be made of a heat resistant material capable of withstanding oven temperatures and repeated baking cycles. The material should be resistant to hydrolysis or corrosion that may occur from repeated wash cycles. The material must be approved for safe contact with food. If the components are made from metal, machining, forming or molding may be the primary method of manufacture.

The material chosen for this design is a heat resistant, FDA approved plastic from Solvay called Duradex 3000. It is injected into a mold that is consistent with the geometry shown in the enclosed drawings (reference FIG. 1 and FIG. 2). The mold shall be machined to allow for shrinkage consistent with said processes and material.

Examples of suitable plastic materials are thermal plastics such as polysulfones (PSU), polyether sulfones (PES), polyphenyl sulfones (PPSU), polyphenylene sulfides (PPS), polyether sulfides (PEI), polyketones, polyamides, liquid crystal polymer (LCP), PPI, PEEK, PAEK, co-polymers or alloys of the above mentioned materials or other thermal plastic materials.

### OPERATION OF THE INVENTION

The methods employed to utilize the Muffinmeal™ baking accessory to create cavities of various shapes and sizes are detailed in the following statements.

The Muffinmeal™ baking accessory consist of two components. The cavity forming attachment (round forming attachment shown in FIG. 1) and the base/stem embodiment shown in FIG. 2 are both utilized as an assembly to form the desired cavity size and shape during the baking process.

Prior to filling the baking pan with the mixture to be baked, the base/stem component is set into the baking container with the stem (identified in FIG. 2) pointed upward and the base seated flat on the bottom of the respective baking pan. If using a cupcake or muffin pan a base/stem component will be placed in each cavity. If using a larger cake baking pan the base/stem components can be arrange to form cavities in any location/pattern the user desires.

After positioning the base/stem components in the baking pan the baking mixture is added to the baking cavity. The stem of the base/stem component should be visible after adding the baking mixture. Position the cavity forming attachment (round forming attachment shown in FIG. 1) with the open end positioned away from the baking pan. Align the hole at the base of the cavity forming attachment with the stem and press downward. The cavity forming attachment will slide down the stem to the desired depth. The user will position the cavity forming attachment lower (further down the stem) to produce a larger cavity and higher to produce a smaller cavity. The interface between the stem and the receiving hole in the base of the cavity forming attachment allow for repeatable vertical adjustment of the cavity forming attachments.

The mixture is ready to bake per recommended baking instructions, Once the baking process is complete and allowed to cool the cavity forming attachments can be removed by pulling upward and away from the base/stem.

Alternative cavity forming attachments can be used during the baking process. These attachments are referred to as Muffinshapes™. FIG. 4 shows several of these shapes that allow for the creation of fun shapes enabling youthful

1.) The Muffinmeal™ baking accessory (FIGS. 1 & 2) creates an exposed cavity on top of the baked surface that can be filled with various food products. The exposed cavity allows for the creation of attractive meals or desserts. The creative mind will find ways to fill the cavity with edibles suitable for breakfast, lunch, dinner or attractive desserts. The baking mixture can consist of any edible baking mixture the user desires.)

2.) The utilization of individual cavity forming units allows the user to fill the cavities of a cupcake or muffin pan with different mixtures and bake them concurrently. Different baking mixtures have different rising characteristics that will not affect the finished product because each unit (cavity forming attachment & base/stem component) is individually adjustable allowing for variable baking situations.)

3.) The Muffinmeal™ baking accessory allows the baking mixture to rise and form a naturally baked surface with a rounded top. The embodiments (FIGS. 1 & 2) do not constrict the mixture from rising to create an aesthetically pleasing, naturally rounded baked surface.)

4.) The Muffinmeal™ baking accessory allows the user the flexibility to create cavities of various sizes by vertically positioning the cavity forming attachment to different positions on the stem of the base/stem component. The interface between the stem and the receiving hole in the base of the cavity forming attachment allow for repeatable vertical adjustment of the cavity forming attachments.

5.) The Muffinmeal™ baking accessory allows the user to create baked goods with cavities of various shapes. These fun shapes are called Muffinshapes™. The use of Muffinshapes™ (FIG. 4) provides the entertainment value of creative enjoyment during the decorating process.
